(19) United States
(12) Patent Application Publication
(10) Pub. No.: US 2009/0211408 A1
(43) Pub. Date: Aug. 27, 2009

(54) Spark plug socket wrench

(76) Inventors: Chia Hui Peng, Taichung Hsien (TW); Ying Hao Peng, Taichung Hsien (TW)

Correspondence Address: CHARLES E. BAXLEY, ESQUIRE, 90 JOHN STREET, SUITE 309, NEW YORK, NY, 10038, US

(21) Appl. No.: 12/072,623

(22) Filed: Feb. 27, 2008

(51) Int. Cl. B25B 13/06

(52) U.S. Cl. 81/125

(57) ABSTRACT

A spark plug socket wrench includes a socket member having a non-circular chamber for receiving a nut member of a spark plug, and having an engaging hole for engaging with a driving tool, and having a compartment communicating with the chamber and the engaging hole of the socket member, a casing engaged into the compartment of the socket member and having a space for receiving an insulator of the spark plug, and a spring-biased projection attached to the casing and having a detent biased by a spring member for engaging with the spark plug and for retaining the spark plug to the socket member and for preventing the spark plug from being disengaged from the socket member inadvertently.

### BACKGROUND OF THE INVENTION

1. Field of the Invention

The present invention relates to a spark plug socket wrench, and more particularly to a spark plug socket wrench including a spring-biased projection for engaging with the spark plug and for solidly retaining the spark plug to the socket wrench and for preventing the spark plug from being disengaged from the socket wrench.

2. Description of the Prior Art

Typical spark plug socket wrenches comprise a socket member for receiving or engaging with a spark plug and for rotating or driving the spark plug, and a gripping liner engaged into the socket member for engaging with the spark plug and for stably or solidly retaining the spark plug to the socket wrench and for preventing the spark plug from being disengaged from the socket member inadvertently.

For example, U.S. Pat. No. 2,832,245 to Burrows, and U.S. Pat. No. 2,956,462 to Paul disclose two of the typical spark plug socket wrenches each also comprising a gripping liner or insert engaged into the socket member for engaging with the spark plug and for stably gripping or retaining the spark plug to the socket wrench.

However, the gripping liner or insert is made of soft or resilient materials that may not resist the high temperature of the spark plug and that may be easily and quickly damaged after use.

U.S. Pat. No. 3,745,861 to Totsu et al. discloses another typical plug holding socket comprising a frust-conical coil having at least three stages for engaging with or for gripping the spark plug to the plug holding socket.

However, the frust-conical coil may not be easily bent and formed and may not be used for engaging with or for gripping various kinds of spark plugs.

U.S. Pat. No. 3,924,492 to Bray discloses a further typical spark plug socket wrench comprising a protuberance or metallic ring press-fitted within the socket wrench.

However, the protuberance or metallic ring includes a bore having a predetermined-inner diameter and may not be used to engage with or to grip various kinds of spark plugs.

U.S. Pat. No. 5,074,372 to Fetter et al. discloses a still further typical spark plug socket wrench comprising a leaf spring engaged into a wrench socket for engaging with or for gripping the spark plug to the wrench socket.

However, the leaf spring may not be easily secured to the wrench socket, and the wrench socket is required to be machined with a groove for engaging with the leaf spring, such that the wrench socket will be spoiled, or the strength of the wrench socket will be decreased, and it will be difficult to form the groove in the wrench socket.

U.S. Pat. No. 5,074,373 to Cearley discloses a still further typical spark plug socket wrench comprising a resilient liner located in the wrench socket for engaging with or for gripping the insulation sheath of the spark plug to retain the spark plug within the wrench socket.

However, the resilient liner is made of soft or resilient or rubber or other type of elastomeric materials that may not resist the high temperature of the spark plug and that may be easily and quickly damaged after use.

U.S. Pat. No. 6,182,537 to Vasichek et al. discloses a still further typical spark plug socket wrench comprising a disk engaged into a wrench socket for engaging with or for gripping the spark plug to the wrench socket, and a magnet engaged into the disk for engaging with the spark plug and for stably retaining the spark plug to the wrench socket.

However, the magnet may not be used to act onto or to attract the insulation sheath of the spark plug such that the spark plug may not be solidly or stably retained to the wrench socket with the magnet.

The present invention has arisen to mitigate and/or obviate the afore-described disadvantages of the conventional spark plug socket wrenches.

### SUMMARY OF THE INVENTION

The primary objective of the present invention is to provide a spark plug socket wrench including a spring-biased projection for engaging with the spark plug and for solidly retaining the spark plug to the socket wrench and for preventing the spark plug from being disengaged from the socket wrench.

In accordance with one aspect of the invention, there is provided a spark plug socket wrench for engaging with a spark plug which includes a nut member and a fragile porcelain insulator, the socket wrench comprising a socket member including a non-circular chamber formed in a first end portion thereof for receiving the nut member of the spark plug, and including an engaging hole formed in a second end portion thereof for receiving a driving shank of a driving tool and for allowing the socket member and the spark plug to be rotated and driven by the driving tool, and including a compartment formed in a middle portion of the socket member and communicating with the chamber and the engaging hole of the socket member, a casing engaged into the compartment of the socket member and including a space formed in the casing for receiving and engaging with the insulator of the spark plug, and a spring-biased projection attached to the casing for engaging with the spark plug and for retaining the spark plug to the socket member and to prevent the spark plug from being disengaged from the socket member and for allowing the spark plug to be stably rotated and driven by the socket member.

The includes an orifice formed therein for receiving the spring-biased projection. The spring-biased projection includes a detent and a spring member engaged into the orifice of the casing, and the detent is biased by the spring member to partially extend into the casing and to selectively engage with the spark plug and to retain the spark plug to the socket member.

The casing includes a cap attached to the casing for blocking the orifice of the casing and for retaining the detent and the spring member in the orifice of the casing. The casing includes a peripheral swelling extended into the orifice for stably engaging with the detent and for preventing the detent from being disengaged from the casing.

The casing includes a peripheral flange having the orifice formed through the peripheral flange for receiving the spring-biased projection. The spring-biased projection includes a detent and a spring member engaged into the orifice of the peripheral flange, and the detent is biased or forced by the spring member to partially extend into the peripheral flange and to selectively engage with the spark plug in order to stably retain the spark plug to the socket member.

The casing includes a cap attached to the peripheral flange for blocking the orifice of the peripheral flange and for retaining the detent and the spring member in the orifice of the peripheral flange of the casing.

The casing includes a peripheral swelling extended into the orifice for engaging with the detent and for preventing the detent from being disengaged from the peripheral flange of the casing. The casing includes an inner peripheral recess formed in the peripheral flange for engaging with a retaining ring of the spring-biased projection.

The casing may further include an inner peripheral recess formed therein, and the spring-biased projection includes a retaining ring engaged in the inner peripheral recess of the casing for engaging with the spark plug and for retaining the spark plug to the socket member.

Further objectives and advantages of the present invention will become apparent from a careful reading of the detailed description provided hereinbelow, with appropriate reference to the accompanying drawings.

### BRIEF DESCRIPTION OF THE DRAWINGS

FIG. 1 is an exploded view of a spark plug socket wrench in accordance with the present invention;

FIG. 2 is another exploded view illustrating the operation of the spark plug socket wrench with a spark plug and by a driving tool;

FIG. 3 is a partial cross sectional view of the spark plug socket wrench taken along lines 3-3 of FIG. 2;

FIG. 4 is an enlarged partial cross sectional view of the spark plug socket wrench;

FIG. 5 is another partial cross sectional view similar to FIG. 3, illustrating the operation of the spark plug socket wrench;

FIG. 6 is a further exploded view illustrating the other arrangement of the spark plug socket wrench;

FIG. 7 is a cross sectional view of the spark plug socket wrench as shown in FIG. 6;

FIG. 8 is an enlarged partial cross sectional view of the spark plug socket wrench as shown in FIGS. 6 and 7;

FIG. 9 is a still further exploded view illustrating the further arrangement of the spark plug socket wrench;

FIG. 10 is a cross sectional view of the spark plug socket wrench as shown in FIG. 9;

FIG. 11 is an enlarged partial cross sectional view of the spark plug socket wrench as shown in FIGS. 9 and 10;

FIG. 12 is a further partial cross sectional view similar to FIG. 10, illustrating the operation of the spark plug socket wrench as shown in FIGS. 9-11;

FIG. 13 is a still further exploded view illustrating the still further arrangement of the spark plug socket wrench;

FIGS. 14, 15 are cross sectional views illustrating the operation of the spark plug socket wrench as shown in FIG. 13;

FIG. 16 is a still further exploded view illustrating the still further arrangement of the spark plug socket wrench; and

FIG. 17 is a cross sectional view of the spark plug socket wrench as shown in FIG. 16.

### DETAILED DESCRIPTION OF THE PREFERRED EMBODIMENT

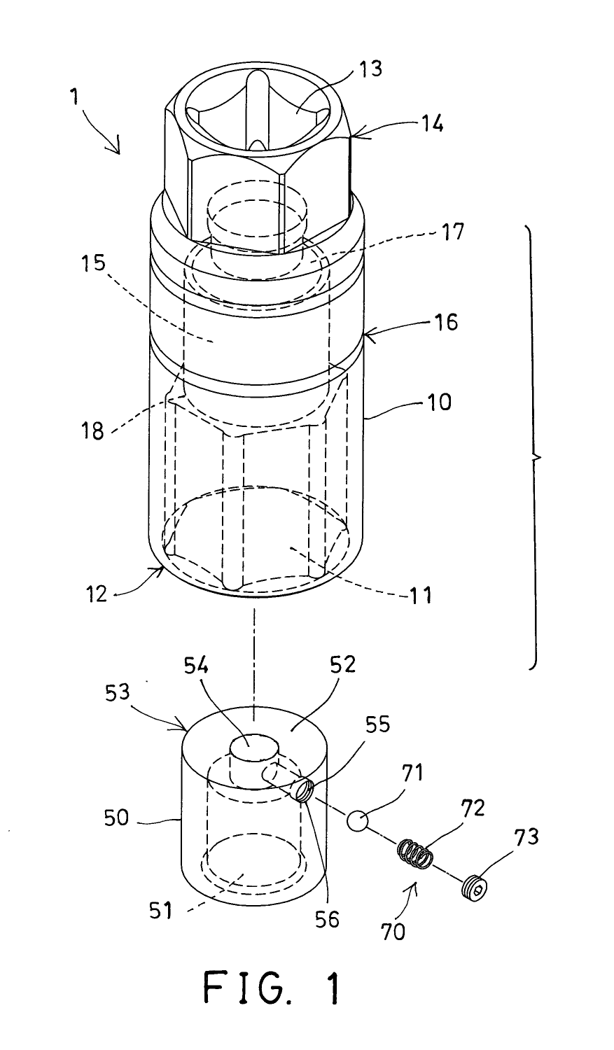

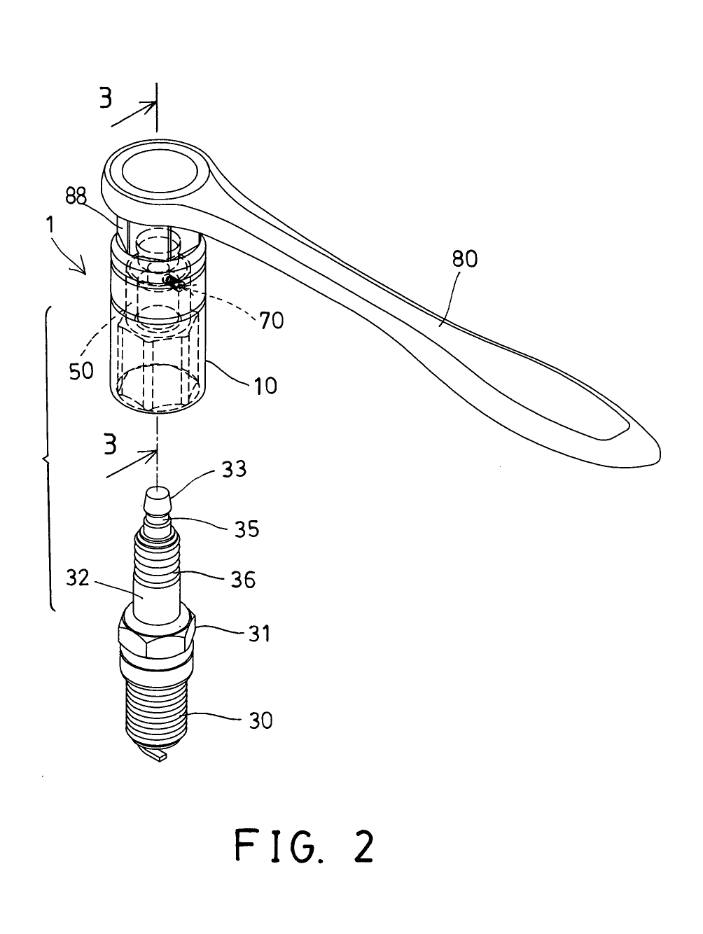

Referring to the drawings, and initially to FIGS. 1-4, a spark plug socket wrench 1 in accordance with the present invention comprises a socket member 10 provided for engaging with a spark plug 30 and for allowing the spark plug 30 and the socket member 10 to be rotated or driven by a driving tool 80, in which the spark plug 30 includes a hexagonal portion or a nut member 31 for being engaged with the socket member 10 and for being rotated or driven by the socket member 10, and includes a fragile porcelain insulator 32, and includes a connecting nut 33 threaded on a central conductor 34 and extended beyond the upper end of the insulator 32 and having a peripheral groove 35 formed in the connecting nut 33, and includes one or more peripheral slots 36 formed in the fragile porcelain insulator 32.

The socket member 10 includes a hexagonal or non-circular chamber 11 formed in the one end or lower portion 12 thereof for receiving or engaging with the nut member 31 of the spark plug 30, and includes an engaging hole 13 formed in the other end or upper portion 14 thereof for receiving or engaging with a driving shank 88 of the driving tool 80 and for allowing the socket member 10 and the spark plug 30 to be rotated or driven by the driving tool 80, and includes a compartment 15 formed in the middle portion 16 of the socket member 10 and communicating with the chamber 11 and the engaging hole 13 of the socket member 10, in which the compartment 15 includes an inner diameter smaller than that of the chamber 11 but greater than that of the engaging hole 13 of the socket member 10 for forming two peripheral shoulders 17, 18 in the socket member 10.

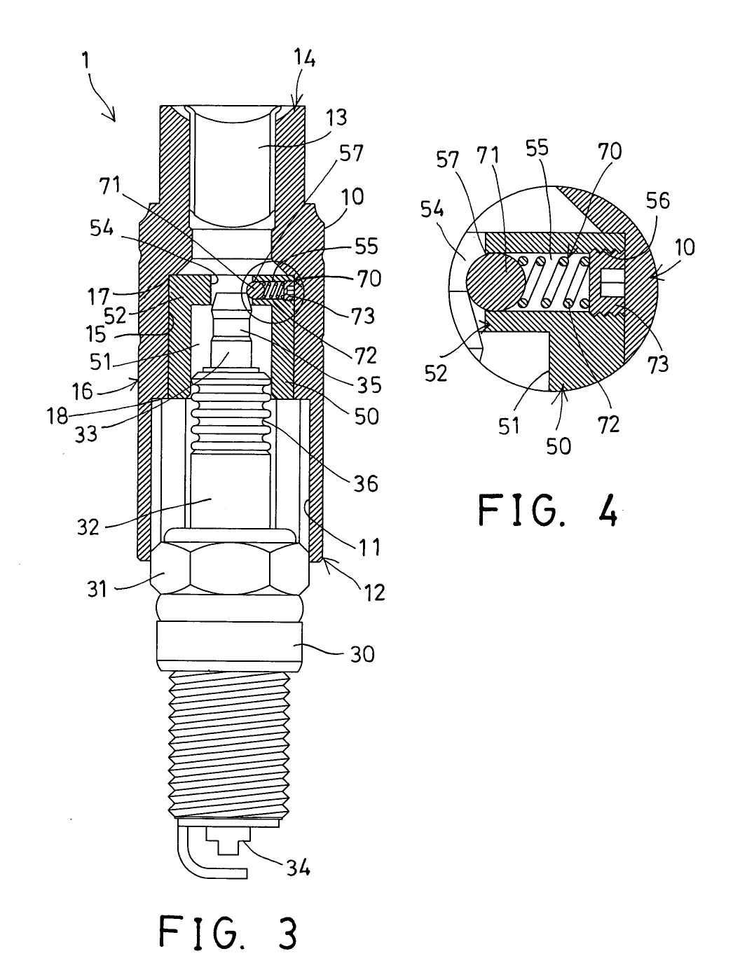

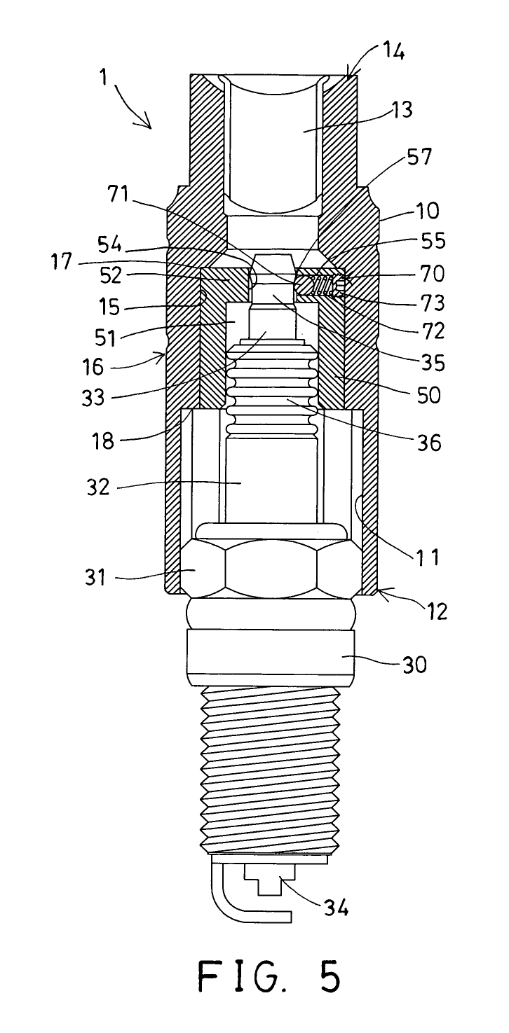

For example, one of the peripheral shoulders 17 is formed and located between the compartment 15 and the engaging hole 13 of the socket member 10, and the other peripheral shoulder 18 is formed and located between the compartment 15 and the chamber 11 of the socket member 10, and the compartment 15 of the socket member 10 may be provided for receiving or engaging with the fragile porcelain insulator 32 and the connecting nut 33 of the spark plug 30, best shown in FIGS. 3 and 5, and thus for allowing the spark plug 30 to be suitably rotated or driven by the socket member 10. The above-described structure including the driving tool 80 and the spark plug 30 is typical and will not be described in further details.

The spark plug socket wrench 1 further includes a cylindrical liner or insert or casing 50 made of such as plastic, metal, porcelain or other materials that may resist high temperatures, and engaged or force-fitted into the compartment 15 of the socket member 10 and engaged with the peripheral shoulder 17 of the socket member 10, and having a space 51 formed in the casing 50 for receiving or engaging with the fragile porcelain insulator 32 and the connecting nut 33 of the spark plug 30, and having a peripheral flange 52 extended radially and inwardly from one end or upper portion 53 thereof for forming or defining an opening 54 in the peripheral flange 52, in which the opening 54 of the casing 50 includes an inner diameter smaller than that of the space 51 of the casing 50 for such as snugly receiving or engaging with the connecting nut 33 of the spark plug 30. The casing 50 further includes an orifice 55 laterally formed therein, such as laterally formed through the peripheral flange 52 for receiving or engaging with a spring-biased projection 70 which may be attached or engaged with the peripheral flange 52 or the casing 50.

For example, the casing 50 includes an inner thread 56 formed in the outer portion of the orifice 55 of the casing 50, and includes a peripheral swelling 57 extended radially and inwardly from the inner portion of the orifice 55 of the peripheral flange 52 for engaging with the spring-biased projection 70 and for preventing the spring-biased projection 70 from being disengaged from the peripheral flange 52 of the casing 50, in which the spring-biased projection 70 includes a ball or detent 71 and a spring member 72 engaged into the orifice 55 of the peripheral flange 52 and a lock nut or cap 73 threaded or attached or engaged with the inner thread 56 of the peripheral flange 52 and/or of the casing 50 for blocking the orifice 55 of the peripheral flange 52 and for retaining the detent 71 and the spring member 72 in the orifice 55 of the peripheral flange 52.

In operation, as shown in FIGS. 3-5, the peripheral swelling 57 may be engaged with the detent 71 for retaining the detent 71 in the orifice 55 of the peripheral flange 52 and for preventing the detent 71 from being disengaged from the peripheral flange 52 of the casing 50, and the spring member 72 may bias and force the detent 71 to partially extend into the opening 54 of the casing 50 or of the peripheral flange 52 in order to selectively engage with the peripheral groove 35 of the connecting nut 33 (FIG. 5) and to stably or solidly retain the spark plug 30 to the socket member 10 and to prevent the spark plug 30 from being disengaged from the socket member 10 and thus for allowing the spark plug 30 to be suitably and stably or solidly rotated or driven by the socket member 10 and the driving tool 80.

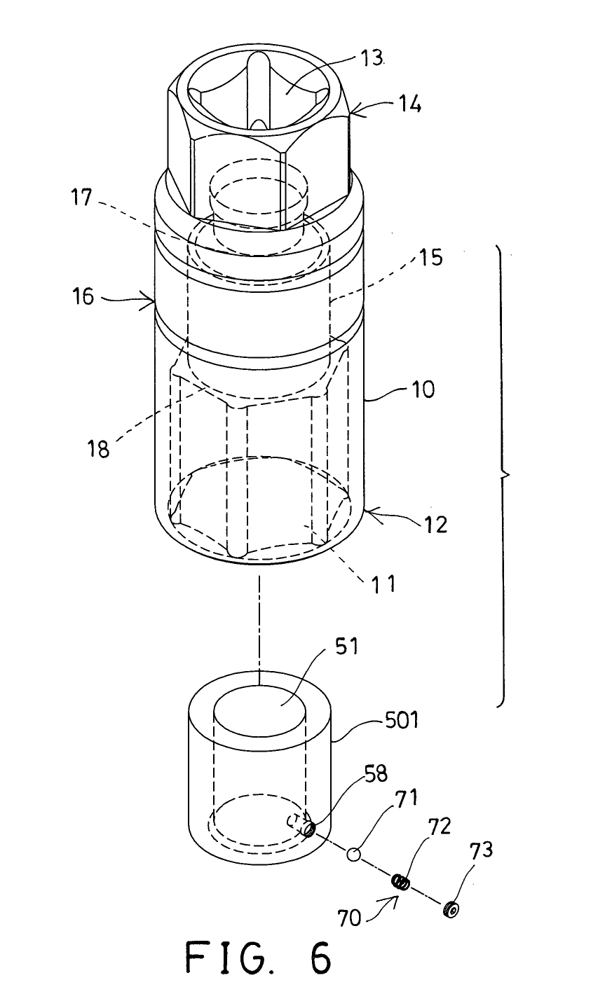

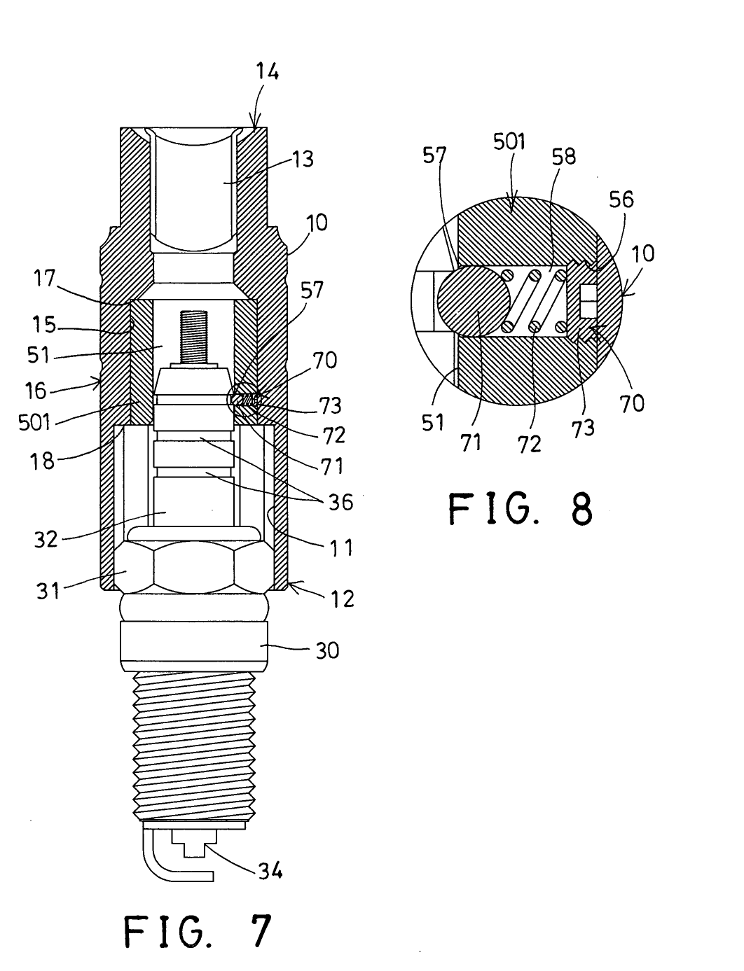

Alternatively, as shown in FIGS. 6-8, the casing 501 may include an orifice 58 laterally and directly formed in the casing 501, but not in the peripheral flange 52 as shown in FIGS. 1-5, and also provided for receiving or engaging with the spring-biased projection 70 which also includes a ball or detent 71 biased by a spring member 72 to engage with either of the peripheral slots 36 of the fragile porcelain insulator 32 of the spark plug 30 and to stably or solidly retain the spark plug 30 to the socket member 10 and to prevent the spark plug 30 from being disengaged from the socket member 10 and thus for allowing the spark plug 30 to be suitably and stably or solidly rotated or driven by the socket member 10 and the driving tool 80.

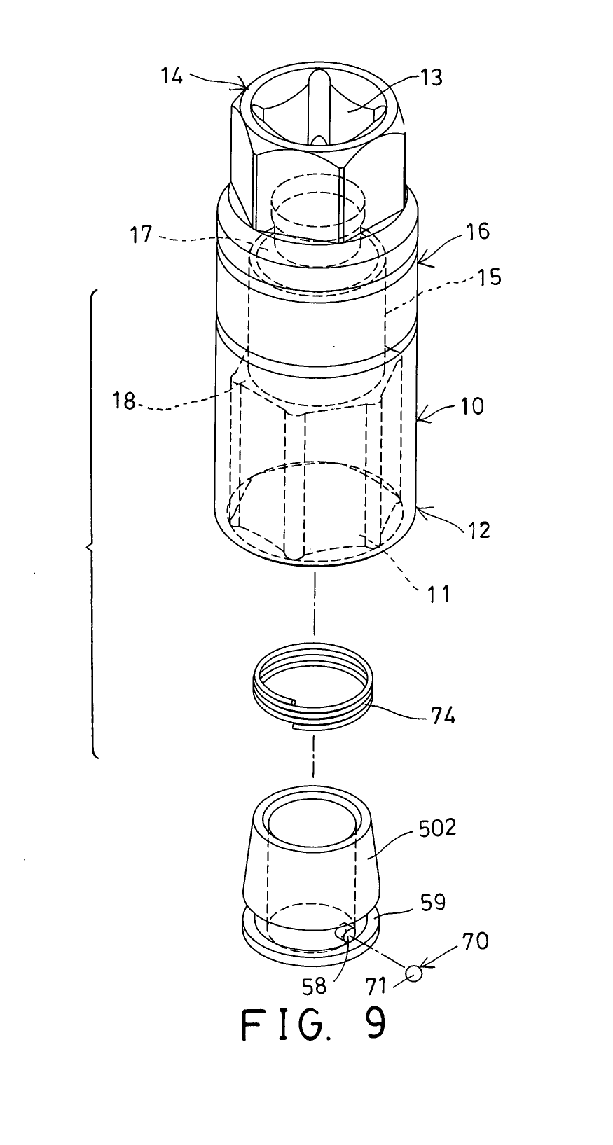

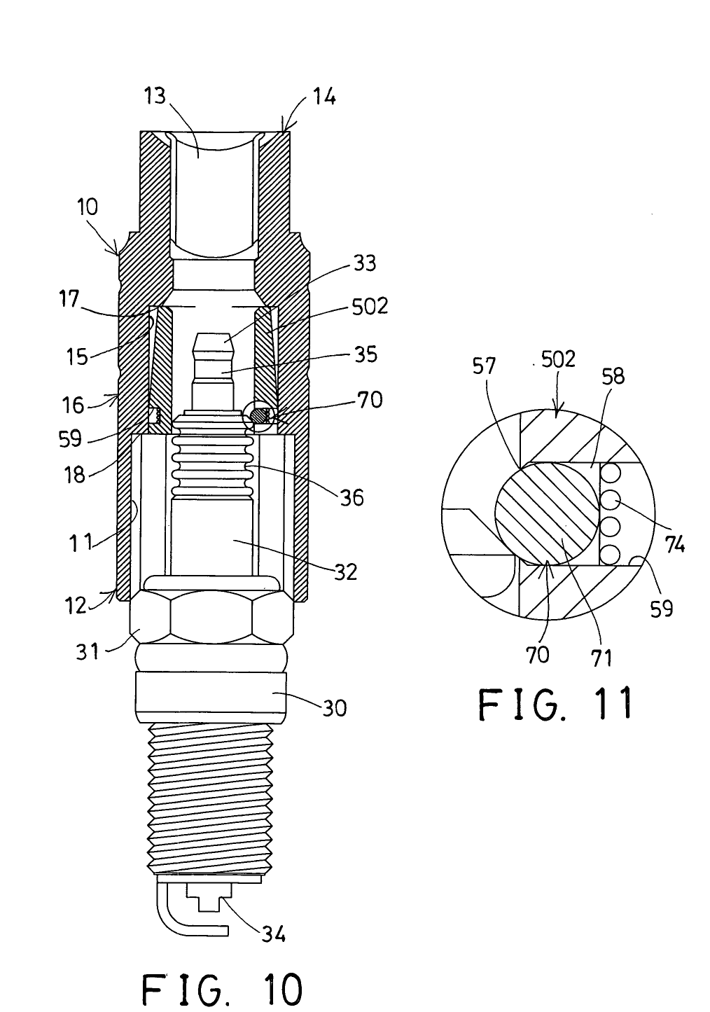

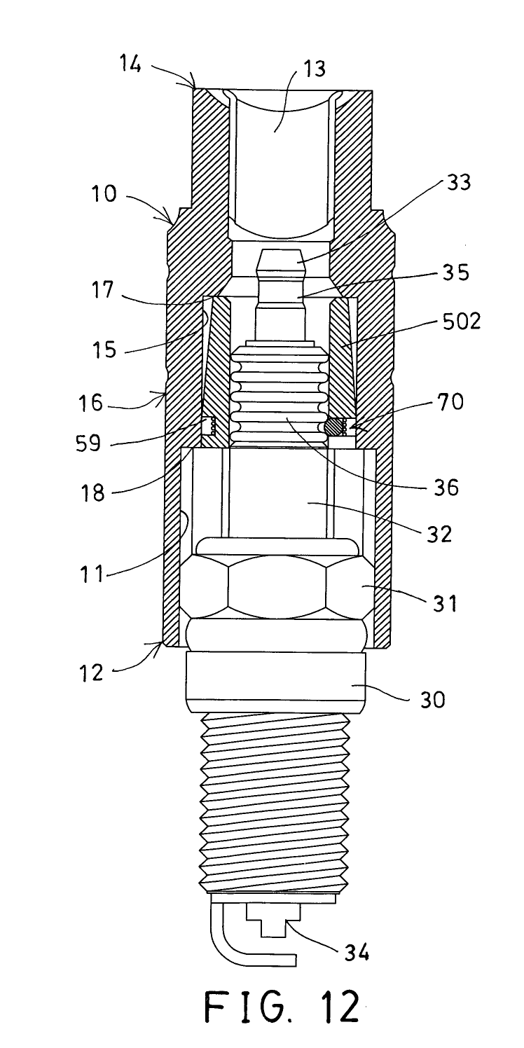

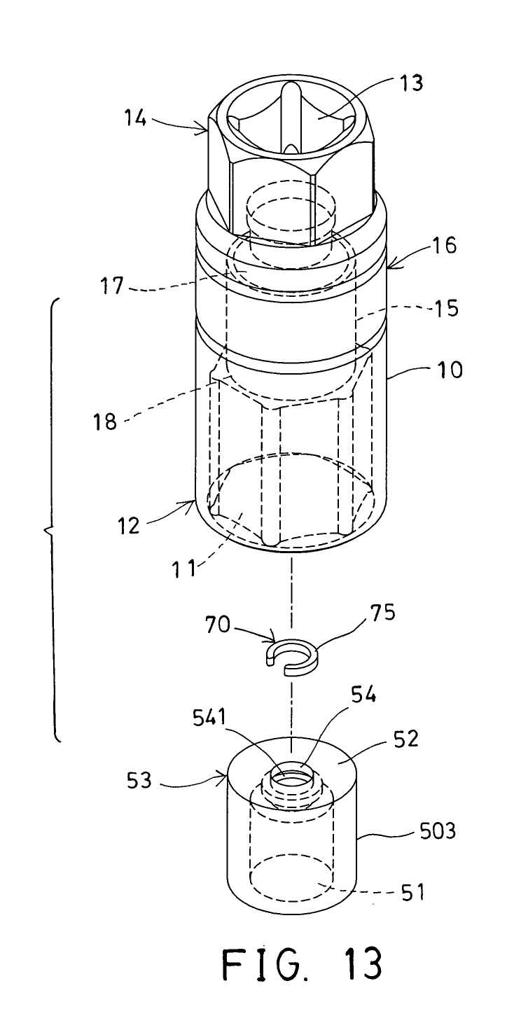

Further alternatively, as shown in FIGS. 9-12, in addition to the orifice 58 in the casing 501, the casing 502 may include an outer peripheral channel 59 formed in the outer peripheral portion thereof for receiving another spring member 74 which may be engaged with the detent 71 of the spring-biased projection 70 for biasing and forcing the detent 71 to engage with either of the peripheral slots 36 of the fragile porcelain insulator 32 of the spark plug 30 and to stably or solidly retain the spark plug 30 to the socket member 10 and to prevent the spark plug 30 from being disengaged from the socket member 10 and thus for allowing the spark plug 30 to be suitably and stably or solidly rotated or driven by the socket member 10 and the driving tool 80.

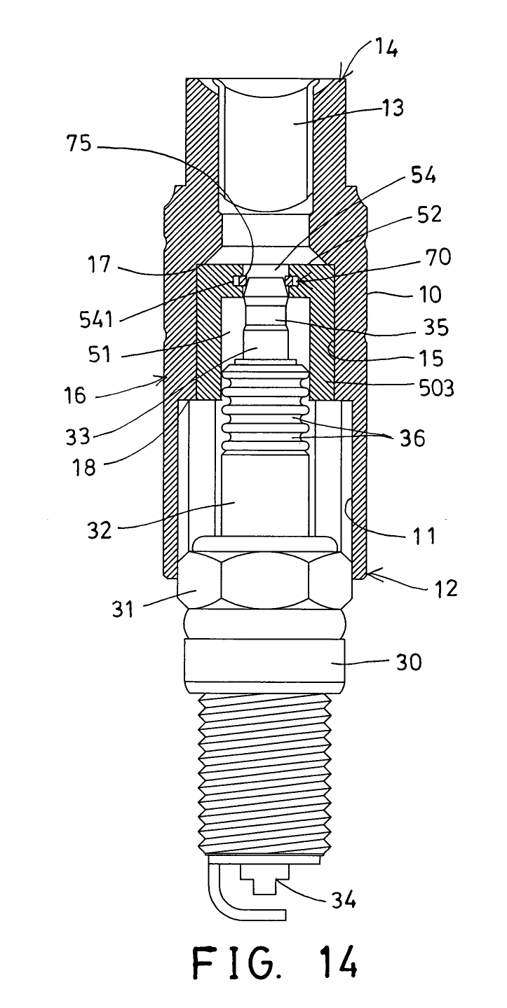

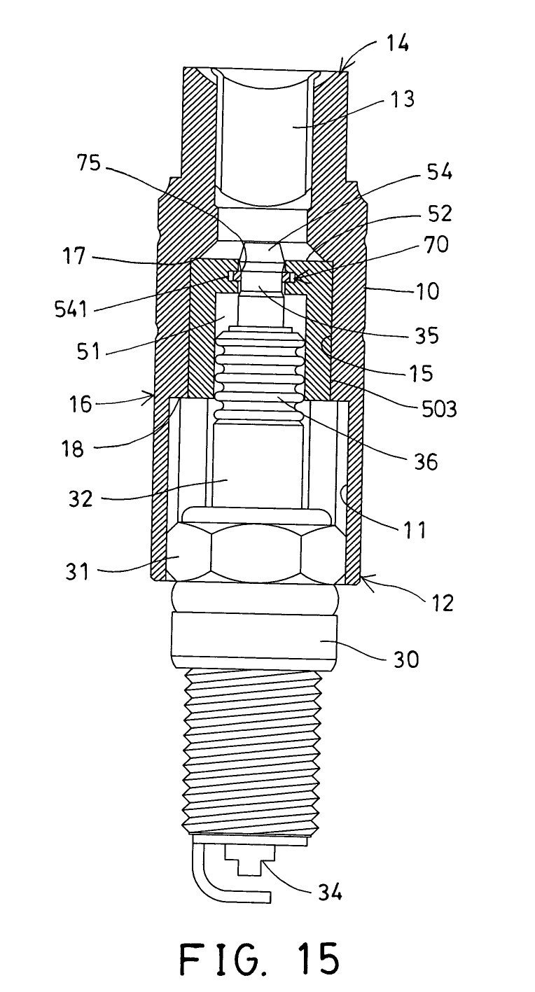

Further alternatively, as shown in FIGS. 13-15, the casing 503 may include an inner peripheral recess 75 formed in the inner peripheral portion of the peripheral flange 52 for receiving or engaging with a clamping ring or retaining ring 75 of the spring-biased projection 70 which may be partially extended into the opening 54 of the casing 503 or of the peripheral flange 52 in order to selectively engage with either of the peripheral slots 36 of the fragile porcelain insulator 32 of the spark plug 30 and to stably or solidly retain the spark plug 30 to the socket member 10 and to prevent the spark plug 30 from being disengaged from the socket member 10 and thus for allowing the spark plug 30 to be suitably and stably or solidly rotated or driven by the socket member 10 and the driving tool 80.

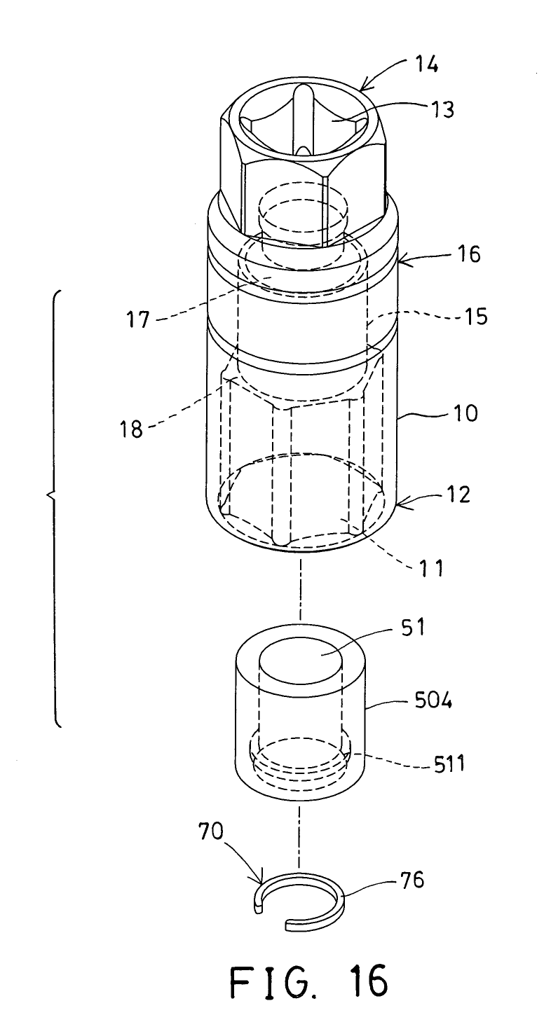

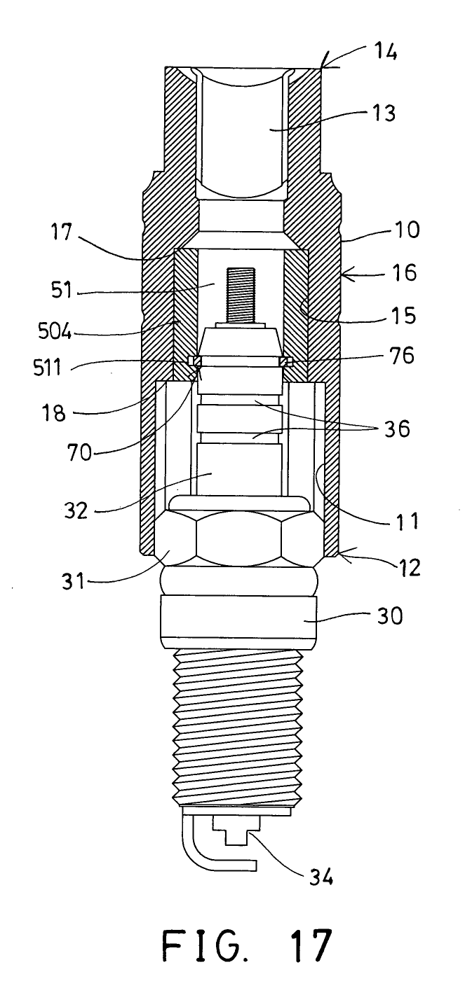

Further alternatively, as shown in FIGS. 16-17, the casing 504 may include an inner peripheral recess 511 formed in the inner peripheral portion thereof and communicating with the space 51 of the casing 504, but not in the peripheral flange 52, for receiving or engaging with a clamping ring or retaining ring 76 of the spring-biased projection 70 which may also be partially extended into the space 51 of the casing 504 in order to selectively engage with either of the peripheral slots 36 of the fragile porcelain insulator 32 of the spark plug 30 and to stably or solidly retain the spark plug 30 to the socket member 10 and to prevent the spark plug 30 from being disengaged from the socket member 10 inadvertently and thus for allowing the spark plug 30 to be suitably and stably or solidly rotated or driven by the socket member 10 and the driving tool 80.

It is to be noted that the detent 71 and the spring member 72 and the retaining rings 75, 76 may be made of such as plastic, metal, porcelain or other materials that may resist high temperatures and may be prevented from being easily and quickly spoiled or damaged by high temperatures after use, and may have a greatly increased working life.

Accordingly, the spark plug socket wrench in accordance with the present invention includes a spring-biased projection for engaging with the spark plug and for solidly retaining the spark plug to the socket wrench and for preventing the spark plug from being disengaged from the socket wrench.

Although this invention has been described with a certain degree of particularity, it is to be understood that the present disclosure has been made by way of example only and that numerous changes in the detailed construction and the combination and arrangement of parts may be resorted to without departing from the spirit and scope of the invention as hereinafter claimed.

I claim:

1. A spark plug socket wrench for engaging with a spark plug which includes a nut member and a fragile porcelain insulator, said socket wrench comprising:
a socket member including a non-circular chamber formed in a first end portion thereof for receiving the nut member of the spark plug, and including an engaging hole formed in a second end portion thereof for receiving a driving shank of a driving tool and for allowing said socket member and the spark plug to be rotated and driven by the driving tool, and including a compartment formed in a middle portion of said socket member and communicating with said chamber and said engaging hole of said socket member,
a casing engaged into said compartment of said socket member and including a space formed in said casing for receiving and engaging with the insulator of the spark plug, and
a spring-biased projection attached to said casing for engaging with the spark plug and for retaining the spark plug to said socket member and to prevent the spark plug from being disengaged from said socket member and for allowing the spark plug to be stably rotated and driven by said socket member.

2. The spark plug socket wrench as claimed in claim 1, wherein said casing includes an orifice formed therein for receiving said spring-biased projection.

3. The spark plug socket wrench as claimed in claim 2, wherein said spring-biased projection includes a detent and a spring member engaged into said orifice of said casing, and said detent is biased by said spring member to partially extend into said casing and to selectively engage with the spark plug and to retain the spark plug to said socket member.

4. The spark plug socket wrench as claimed in claim 3, wherein said casing includes a cap attached to said casing for blocking said orifice of said casing and for retaining said detent and said spring member in said orifice of said casing.

5. The spark plug socket wrench as claimed in claim 3, wherein said casing includes a peripheral swelling extended into said orifice for engaging with said detent and for preventing said detent from being disengaged from said casing.

6. The spark plug socket wrench as claimed in claim 2, wherein said casing includes a peripheral flange having said orifice formed through said peripheral flange for receiving said spring-biased projection.

7. The spark plug socket wrench as claimed in claim 6, wherein said spring-biased projection includes a detent and a spring member engaged into said orifice of said peripheral flange, and said detent is biased by said spring member to partially extend into said peripheral flange and to selectively engage with the spark plug and to retain the spark plug to said socket member.

8. The spark plug socket wrench as claimed in claim 7, wherein said casing includes a cap attached to said peripheral flange for blocking said orifice of said peripheral flange and for retaining said detent and said spring member in said orifice of said peripheral flange of said casing.

9. The spark plug socket wrench as claimed in claim 7, wherein said casing includes a peripheral swelling extended into said orifice for engaging with said detent and for preventing said detent from being disengaged from said peripheral flange of said casing.

10. The spark plug socket wrench as claimed in claim 6, wherein said casing includes an inner peripheral recess formed in said peripheral flange for engaging with a retaining ring of said spring-biased projection.

11. The spark plug socket wrench as claimed in claim 1, wherein said casing includes an inner peripheral recess formed therein, and said spring-biased projection includes a retaining ring engaged in said inner peripheral recess of said casing for engaging with the spark plug and for retaining the spark plug to said socket member.
